(19) United States
(12) Patent Application Publication
(10) Pub. No.: US 2020/0149926 A1
(43) Pub. Date: May 14, 2020

(54) Encoder With Toothed Structure and Apparatus Having the Same

(71) Applicant: Hiwin Mikrosystem Corp., Taichung (TW)

(72) Inventors: Heng-Sheng Hsiao, Taichung (TW); Zhi-Hao Xu, Taichung (US); Chih-Mao Hsiao, Taichung (TW)

(21) Appl. No.: 16/183,846

(22) Filed: Nov. 8, 2018

(51) Int. Cl. G01D 5/16; G01D 5/14

(52) U.S. Cl. CPC G01D 5/16; G01D 5/145

(57) ABSTRACT

An encoder includes a main body and a toothed encoding unit. The main body is made of material with magnetic permeability. The toothed encoding unit is made of material with magnetic permeability, and includes a toothed encoding set and a position toothed encoding set that are disposed on the main body. The toothed encoding set includes a plurality of recesses that are disposed in a first direction. Each of the recesses of the toothed encoding set extends in a second direction that is transverse to the first direction. The position toothed encoding set includes a plurality of recesses that are disposed in the second direction. Each of the recesses of the position toothed encoding set extends in the first direction.

### FIELD

The disclosure relates to an encoder, and more particularly to an encoder with toothed structure.

### BACKGROUND

A conventional measuring device disclosed in U.S. Pat. No. 8,836,324 includes a ferromagnetic material component that is formed with toothed structure, and a sensor consisting of juxtaposed giant magnetoresistance sensor and permanent magnet that is disposed for measuring several physical parameters of the ferromagnetic material component.

However, since the ferromagnetic material component has only a single type of toothed structure, only a few of the physical parameters thereof can be measured simultaneously.

### SUMMARY

Therefore, an object of the disclosure is to provide an encoder that can alleviate the drawback of the prior art.

According to an aspect the disclosure, the encoder includes a main body and a toothed encoding unit. The main body is made of material with magnetic permeability. The toothed encoding unit is made of material with magnetic permeability, and includes a toothed encoding set that is disposed on a surface of the main body, and a position toothed encoding set that is adjacent to the toothed encoding set and that is disposed on the surface of the main body on which the toothed encoding set is disposed. The toothed encoding set includes a plurality of recesses that are disposed in a first direction. Each of the recesses of the toothed encoding set extends in a second direction that is transverse to the first direction. The position toothed encoding set includes a plurality of recesses that are disposed in the second direction. Each of the recesses of the position toothed encoding set extends in the first direction.

According to another aspect the disclosure, the encoder includes an annular main body and a toothed encoding unit. The annular main body is made of material with magnetic permeability, surrounds a central axis, and has a first surface and a second surface that is opposite to the first surface. The toothed encoding unit is made of material with magnetic permeability, and includes a toothed encoding set that is disposed on one of the first surface and the second surface of the main body, and that includes a plurality of spaced-apart recesses. Each of the recesses is annular and is centered at the central axis.

According to still another aspect the disclosure, the encoder includes an annular main body and a toothed encoding unit. The annular main body is made of material with magnetic permeability, surrounds a central axis, and includes a first surface and a second surface opposite to the first surface. The toothed encoding unit is made of material with magnetic permeability, and includes a toothed encoding set that is disposed on one of the first surface and the second surface of the main body, and an annular position toothed encoding set that is centered at the central axis, that is adjacent to the toothed encoding set, and that is disposed on the one of the first surface and the second surface of the main body on which the toothed encoding set is disposed. The toothed encoding set includes a plurality of spaced-apart recesses. Each of the recesses of the toothed encoding set is annular and is centered at the central axis. The position toothed encoding set includes a plurality of angularly spaced apart recesses that are disposed around the central axis.

Another object of the disclosure is to provide a toothed encoding apparatus that can alleviate the drawback of the prior art.

According to an aspect the disclosure, the toothed encoding apparatus is mounted to a linear axle for measuring vibration and displacement thereof, and includes the first one of the aforesaid encoders and a sensing unit. The encoder is mounted to and disposed in an extending direction of the linear axle. The sensing unit is spaced apart from the encoder, corresponds in position to the toothed encoding set and the position toothed encoding set of the toothed encoding unit, and includes a sensor for sensing the amplitude of the vibration of the toothed encoding unit, and a magnetic-analog sensing component for sensing magnetic field strength of the toothed encoding unit.

According to another aspect the disclosure, the toothed encoding apparatus is mounted to a rotating shaft for measuring runout thereof, and includes the second or third one of the aforesaid encoders and a sensing unit. The encoder surrounds and is mounted to the rotating shaft. The sensing unit is spaced apart from the encoder, corresponds in position to the toothed encoding unit, and includes a sensor for sensing displacement of the toothed encoding unit, and a magnetic-analog sensing component for sensing magnetic field strength of the toothed encoding unit.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of the encoder according to the disclosure;

FIG. 2 is an enlarged fragmentary perspective view of the first embodiment;

FIG. 3 is a perspective view illustrating a second embodiment of the encoder according to the disclosure;

FIG. 4 is an enlarged fragmentary perspective view of the second embodiment;

FIG. 5 is a perspective view illustrating a third embodiment of the encoder according to the disclosure;

FIG. 6 is an enlarged fragmentary sectional view of the third embodiment taken along line VI-VI in FIG. 5;

FIG. 7 is a perspective view illustrating a fourth embodiment of the encoder according to the disclosure;

FIG. 8 is an enlarged fragmentary perspective view of the fourth embodiment;

FIG. 9 is a perspective view illustrating a fifth embodiment of the encoder according to the disclosure;

FIG. 10 is an enlarged fragmentary perspective view of the fifth embodiment;

FIG. 11 is a perspective view illustrating a sixth embodiment of the encoder according to the disclosure;

FIG. 12 is an enlarged fragmentary perspective view of the sixth embodiment;

FIG. 13 is a perspective view illustrating a seventh embodiment of the encoder according to the disclosure;

FIG. 14 is an enlarged fragmentary perspective view of the seventh embodiment;

FIG. 15 is a perspective view of the first embodiment and a sensing unit being mounted to a linear axle;

FIG. 16 is a perspective view of the fourth embodiment and a sensing unit being mounted to a rotating shaft;

FIG. 17 is a perspective view of the sixth embodiment and the sensing unit being mounted to the rotating shaft;

FIG. 18 is a perspective view of the seventh embodiment and the sensing unit being mounted to the rotating shaft, utilizing a configuration different from that of the sixth embodiment;

FIG. 19 is a flow chart illustrating a process of a toothed encoding apparatus measuring vibration and displacement of the linear axle;

FIG. 20 is a flow chart illustrating a process of a toothed encoding apparatus measuring runout of the rotating shaft; and

FIG. 21 is a flow chart illustrating a process of a toothed encoding apparatus measuring runout and angular displacement of the rotating shaft.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

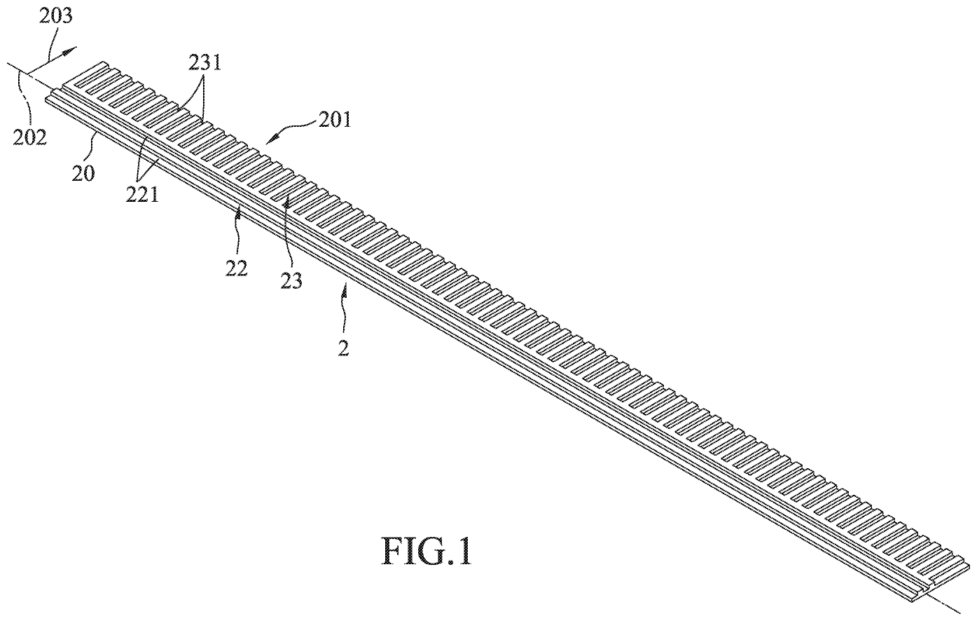

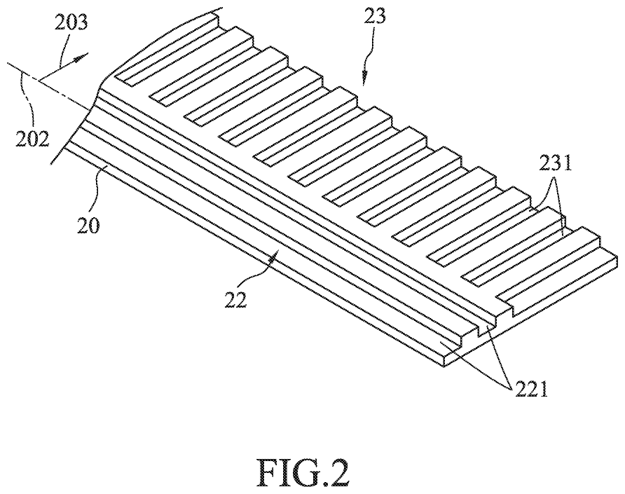

Referring to FIGS. 1 and 2, the first embodiment of the encoder 2 according to the disclosure has a main body 20, and a toothed encoding unit 201 that is disposed on the main body 20.

In some embodiment, the main body 20 is linear and elongated, and extends along an extending axis 202. Each of the main body 20 and the toothed encoding unit 201 is made of a material with magnetic permeability (e.g.,). The toothed encoding unit 201 includes a toothed encoding set 22 that is disposed on a surface of the main body 20, and a position toothed encoding set 23 that is adjacent to the toothed encoding set 22 and that is disposed on the surface of the main body 20 on which the toothed encoding set 22 is disposed.

The toothed encoding set 22 includes a plurality of spaced-apart recesses 221 that are disposed in a lateral direction 203 transverse to the extending axis 202. Each of the recesses 221 of the toothed encoding set 22 extends along the extending axis 202. The position toothed encoding set 23 includes a plurality of spaced-apart recesses 231 that are disposed along the extending axis 202. Each of the recesses 231 of the position toothed encoding set 23 extends in the lateral direction 203. It should be noted that, in this embodiment, the position toothed encoding set 23 is configured to be incremental-type. The number of the recesses 221 of the toothed encoding set 22 and the number of the recesses 231 of the position toothed encoding set 23 are not specifically limited, and can be varied depending on practical demands.

In the first embodiment, since the toothed encoding set 22 and the position toothed encoding set 23 are disposed on the linear main body 20, and since the encoding elements (i.e., the recesses 221) of the toothed encoding set 22 and the encoding elements (i.e., the recesses 231) of the position toothed encoding set 23 are arranged in two different directions, the encoder 2 can be used to measure various physical parameters of a linear axle.

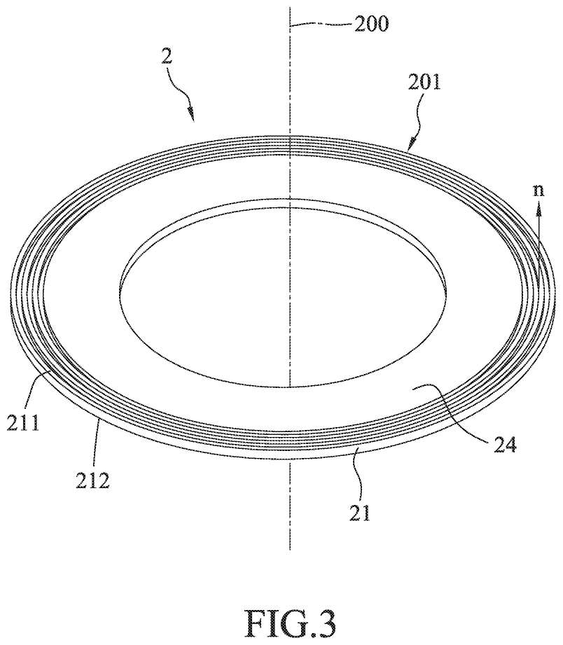

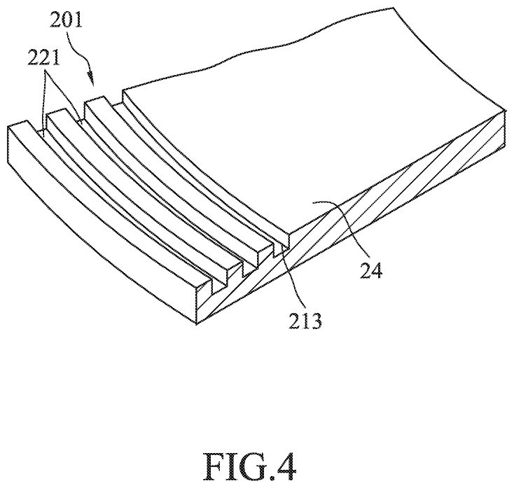

Referring to FIGS. 3 and 4, the second embodiment of the encoder 2 according to the disclosure includes an annular main body 21 that surrounds a central axis 200, a toothed encoding unit 201 that is disposed on the main body 21, and a fixing member 24 that is coupled to the main body 21.

The main body 21 is made of a material with magnetic permeability, and has a first surface 211, a second surface 212 opposite to the first surface 211, and an inner surrounding wall 213 that is proximate to the central axis 200. The toothed encoding unit 201 is made of a material with magnetic permeability, and includes a toothed encoding set 22 that is disposed on the first surface 211 of the main body 21. The toothed encoding set 22 includes a plurality of spaced-apart annular recesses 221, each of which is centered at the central axis 200 (i.e., each of the recesses 221 surrounds the central axis 200).

Specifically, in the second embodiment, the main body 21 is flat and has shape of a disk that surrounds the central axis 200. In geometric terms, a normal (n) of each of the first and second surfaces 211, 212 of the main body 21 is parallel to the central axis 200. The recesses 221 of the toothed encoding unit 201 are arranged in a radial direction of the main body 21. The number of the recesses 221 of the toothed encoding set 22 and the number of the recesses 231 of the position toothed encoding set 23 are not specifically limited, and can be varied depending on practical demands.

The fixing member 24 is mounted to the inner surrounding wall 213 of the main body 21, so that the main body 21 may be mounted to another apparatus easily. In should be noted that, as long as the main body 21 can be mounted to the apparatus, the fixing member 24 may be made of any shape, or may be omitted.

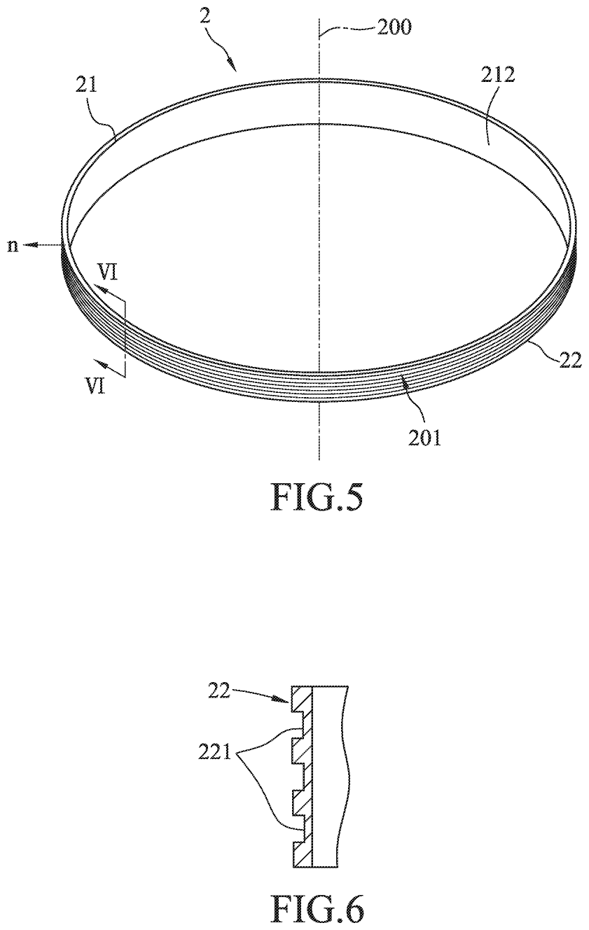

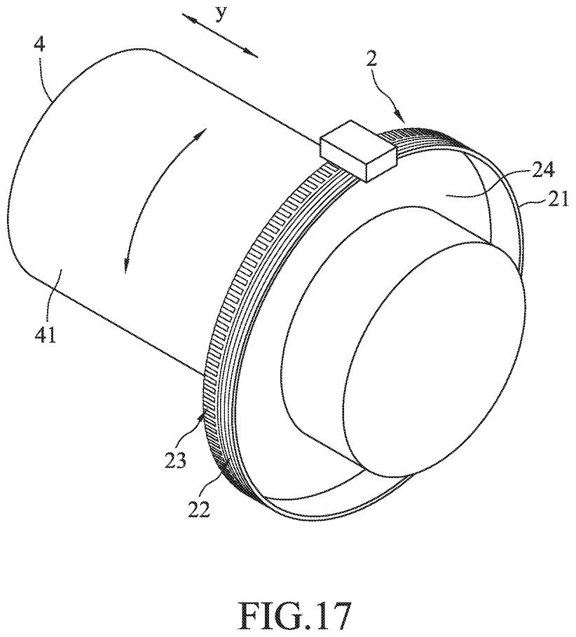

Referring to FIGS. 5 and 6, the third embodiment of the encoder 2 according to the disclosure is similar to the second embodiment, with the following differences. Notably, the main body 21 has shape of a tube that surrounds the central axis 200. In geometric terms, a normal (n) of each of the first and second surfaces 211, 212 is perpendicular to the central axis 200, with the second surface 212 facing the central axis 200, such that the toothed encoding unit 201 disposed on the first surface 211 faces outwardly. In this embodiment, the recesses 221 of the toothed encoding unit 201 are arranged along the central axis 200, and the fixing member 24 (with reference to FIG. 17) is mounted to the second surface 212 of the main body 21.

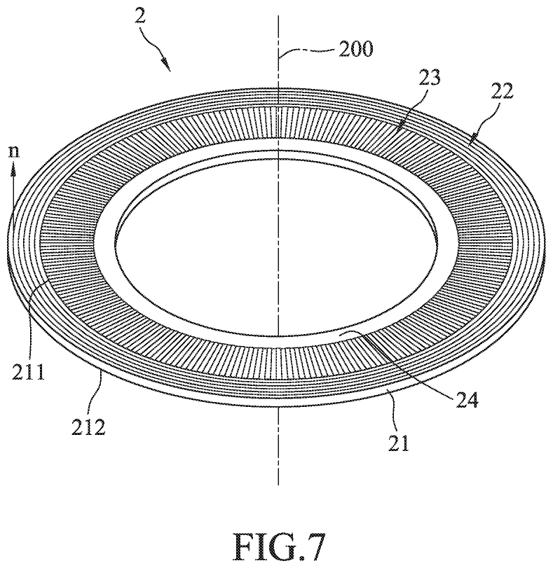

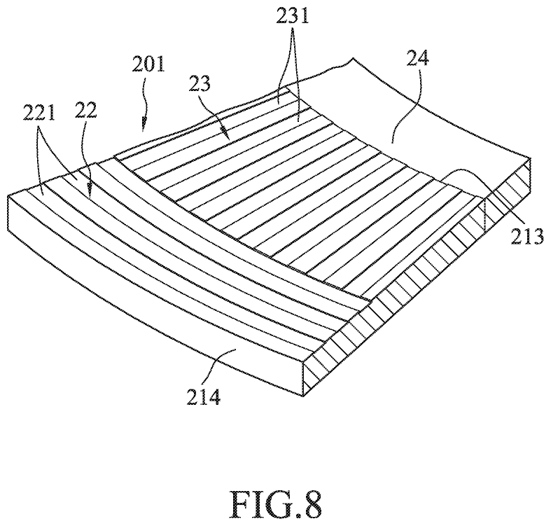

Referring to FIGS. 7 and 8, the fourth embodiment of the encoder 2 according to the disclosure is similar to the second embodiment, with the following differences. The toothed encoding unit 201 further includes a position toothed encoding set 23. The toothed encoding set 22 and the position toothed encoding set 23 are disposed on the first surface 211, and are adjacent to each other. The position toothed encoding set 23 is ring-shaped, and includes a plurality of recesses 231 that are disposed around the central axis 200 and that are angularly spaced apart from each other.

Specifically, in this embodiment, each of the recesses 231 of the position toothed encoding set 23 extends in the radial direction of the main body 21, and the position toothed encoding set 23 is configured to be incremental-type for measuring incremental position (i.e., determining an arbitrary point of the main body 21 as a reference point, and measuring movement of the reference point to obtain relative position of the main body 21). The main body 21 includes an inner surrounding wall 213 that is proximate to the central axis 200 and an outer surrounding wall 214 that is opposite to the inner surrounding wall 213. In this embodiment, the position toothed encoding set 23 is disposed between the toothed encoding set 22 and the inner surrounding wall 213, but may be disposed between the toothed encoding set 22 and the outer surrounding wall 214 in other embodiments.

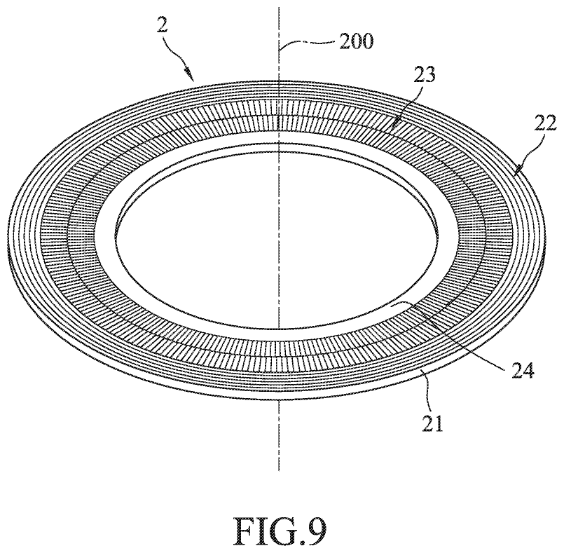

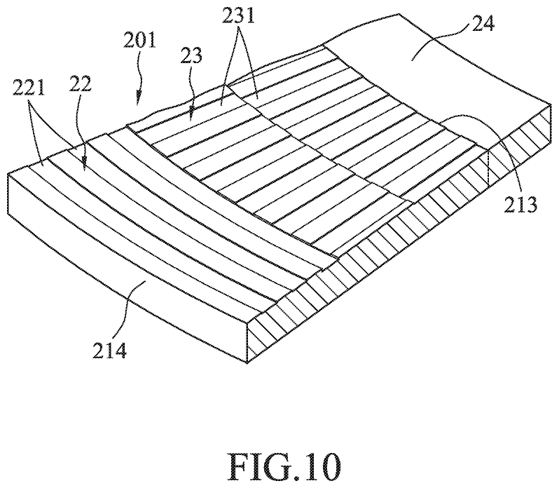

Referring to FIGS. 9 and 10, a fifth embodiment of the encoder 2 according to the disclosure is similar to the fourth embodiment, with the primary difference being the configuration of the position toothed encoding set 23. In the fifth embodiment, the position toothed encoding set 23 is absolute-type, such that it can measure the exact current angular-position of the main body 21 or a rotating shaft to which the main body 21 is mounted. Therefore, the arrangement of the recesses 231 of the position toothed encoding set 23 in the fifth embodiment is different from that in the fourth embodiment. Specifically, the position toothed encoding set 23 has a plurality recesses 231 that are disposed to surround the central axis 200. The specific number and arrangement of the recesses 231 may be adjusted based off user preference as long as the encoder 2 in this embodiment is operable to deliver absolute-type measurements.

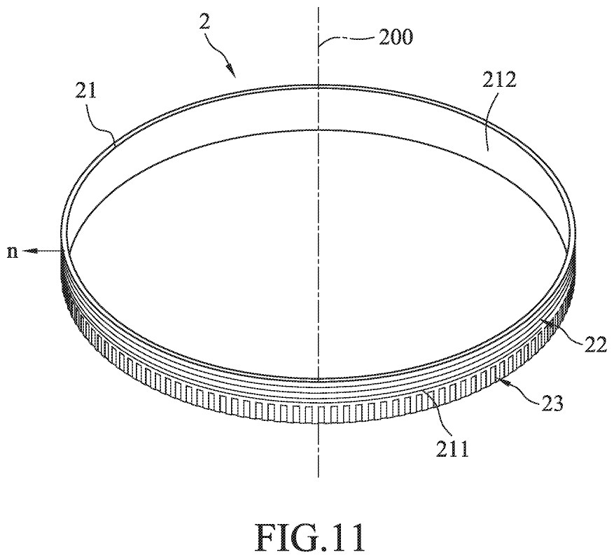

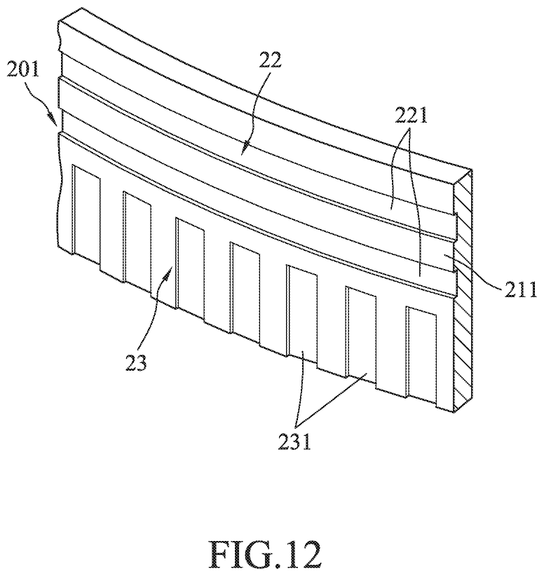

Referring to FIGS. 11 and 12, a sixth embodiment of the encoder 2 according to the disclosure is similar to the third embodiment. The main body 21 has shape of a tube that surrounds the central axis 200. In geometric terms, a normal (n) of each of the first and second surfaces 211, 212 is perpendicular to the central axis 200, with the second surface 212 facing the central axis 200, such that the toothed encoding set 22 and the position toothed encoding set 23 disposed on the first surface 211 face outwardly. The recesses 221 of the toothed encoding set 22, each of which is annular, are arranged along the central axis 200, and the recesses 231 of the position toothed encoding set 23, each of which extends in the direction of the central axis 200, are arranged in a circumferential direction of the main body 21. In this embodiment, the fixing member 24 (referring to FIG. 17), if needed, is mounted to the second surface 212 of the main body 21.

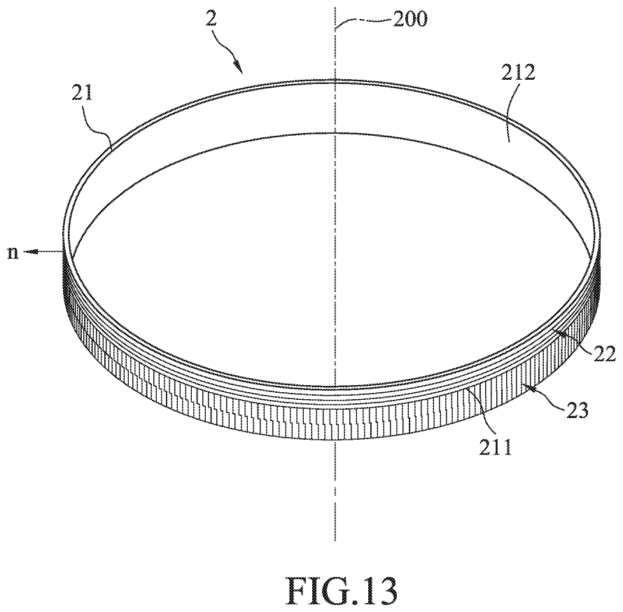

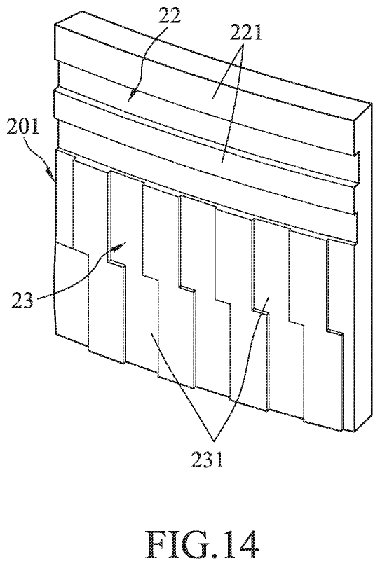

Referring to FIGS. 13 and 14, a seventh embodiment of the encoder 2 according to the disclosure is similar to the sixth embodiment, with the primary difference being the configuration of the position toothed encoding set 23, which is similar to that of the fifth embodiment. The specific number and arrangement of the recesses 231 of the position toothed encoding set 23 may be adjusted based off user preference as long as the encoder 2 in this embodiment is operable to deliver absolute-type measurements.

It should be noted that, by incorporating both the toothed encoding set 22 and the position toothed encoding set 23 on the main body 21, the encoder 2 may measure linearity and lateral and vertical vibration of a linear axle, or runout and the angular-position of a rotating shaft.

To further elaborate how the abovementioned embodiments achieve the measurement of the linear axle or the rotating shaft, a toothed encoding apparatus is utilized.

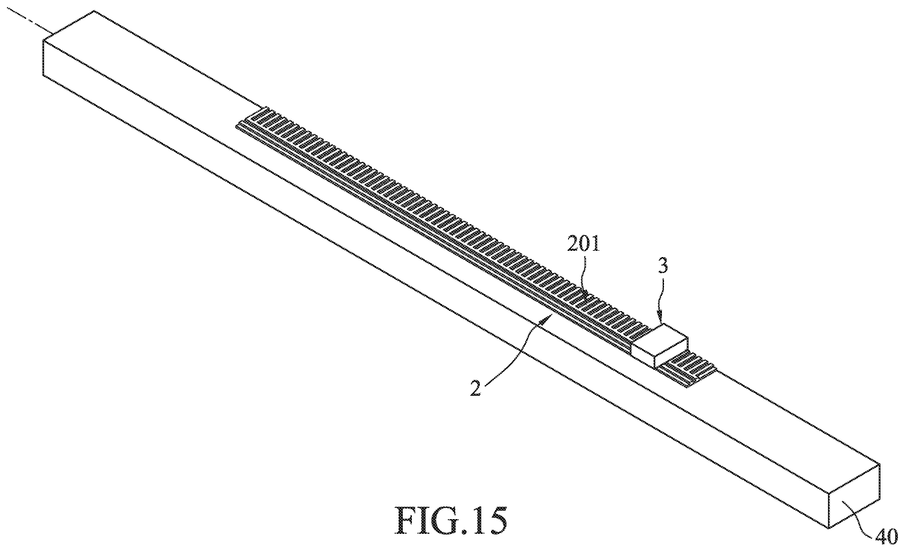

Referring to FIG. 15, the toothed encoding apparatus is adapted to be mounted to a linear axle 40 for measuring vibration and displacement thereof, and includes the encoder 2 of the first embodiment that is co-movably disposed along the linear axle 40, and a sensing unit 3 that is spaced apart from the encoder 2, that corresponds in position to the toothed encoding unit 201, and that includes a sensor (not shown) for sensing the amplitude of the vibration of the toothed encoding unit 201, and a magnetic-analog sensing component (not shown) for sensing magnetic field strength of the toothed encoding unit 201. The sensor and the magnetic-analog sensing component are integrated within the sensing unit 3.

Since the encoder 2 of the first embodiment is linear and elongated, the encoder 2 is mounted to the linear axle at the bottom surface thereof. Meanwhile, the sensing unit 3 is mounted to a fixed position in proximity to the toothed encoding unit 201 for sensing the toothed encoding set 22 and the position toothed encoding set 23. As long as the sensing unit 3 is spaced apart from the toothed encoding unit 201, the configuration of the sensing unit 3 may be different in other embodiments. In addition, the sensor of the sensing unit 3 may be a giant magnetoresistance (GMR) sensor, the magnetic-analog sensing component of the sensing unit 3 may be a Hall Effect sensor, and is not limited to such.

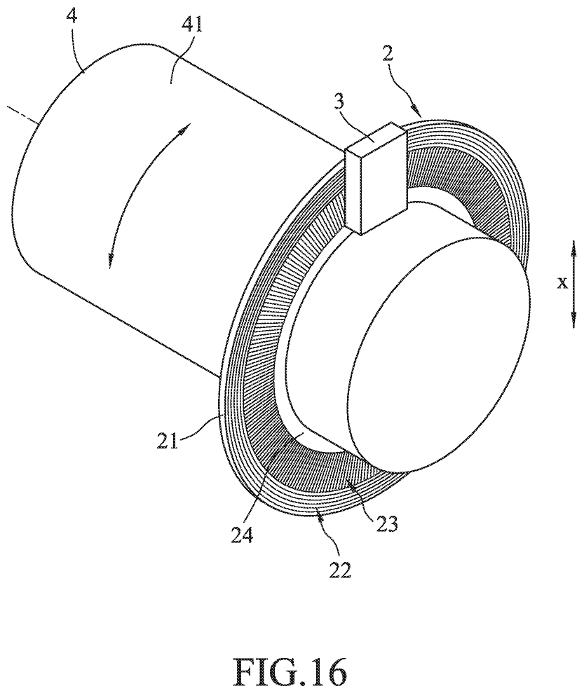

Referring specifically to FIG. 16, another example of the toothed encoding apparatus is adapted to be mounted to a rotating shaft 4. during an assembling process of the toothed encoding apparatus, when the encoder 2 of one of the second, fourth and fifth embodiments is mounted to the rotating shaft 4 (the fourth embodiment is illustrated in FIG. 16), the fixing member 24 connects the main body 21 with the rotating shaft 4, with the inner surrounding wall 213 (with reference to FIG. 8) of the main body 21 of the encoder 2 facing the rotating shaft 4. Meanwhile, the sensing unit 3 is mounted to a fixed position in proximity to the toothed encoding set 22 and the position toothed encoding set 23. As long as the sensing unit 3 is spaced apart from the toothed encoding unit 201, the configuration of the sensing unit 3 may be different in other embodiments.

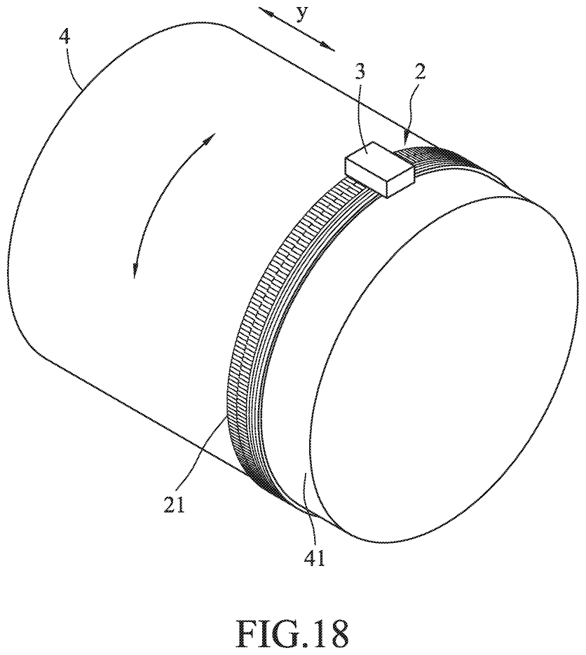

Referring to FIGS. 17 and 18, during another assembling process of the toothed encoding apparatus, when the encoder 2 of one of the third, sixth and seventh embodiments is mounted to the rotating shaft 4 (the sixth embodiment is illustrated in FIG. 17 and the seventh embodiment is illustrated in FIG. 18), the fixing member 24 connects the main body 21 with the rotating shaft 4, with the second surface 212 (with reference to FIG. 11) of the main body 21 of the encoder 2 facing the rotating shaft 4, such that the toothed encoding set 22 and the position toothed encoding set 23 face away from exterior 41 of the rotating shaft 4. Similar to the previous assembly, the sensing unit 3 in this assembly is also spaced apart from the toothed encoding unit 201. In addition, with particular reference to FIG. 18, the encoder 2 may also be mounted to the rotating shaft 4 directly without a fixing member 24, as the second surface 212 of the main body 21 is adapted to be in direct contact with the exterior 41 of the rotating shaft 4.

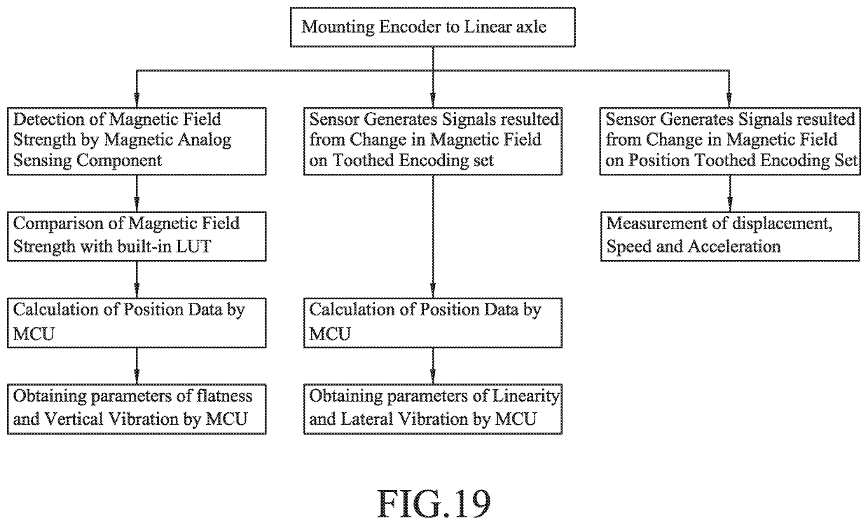

FIG. 19 is presented, alongside FIG. 15, to further elaborate the measuring processes of the toothed encoding apparatus using the encoder 2 of the first embodiment for measuring flatness, linearity, vertical vibration, lateral vibration, displacement, speed and acceleration of the linear axle 40.

During linear movement of the linear axle 40, when the encoder 2 of the first embodiment (see FIG. 1) conducts measurements, the magnetic-analog sensing component of the sensing unit 3 senses the magnetic field strength, via magnetic flux, of the toothed encoding set 22. When distance between the toothed encoding set 22 and the magnetic-analog sensing component changes, the magnetic flux varies accordingly. Such relationship is programmed into a micro-controller unit (MCU, not shown) in the sensing unit 3 to obtain position data from the magnetic flux. After obtaining a value of the magnetic field strength through the magnetic flux, the value is further compared to a built-in look up table (LUT) and processed by the MCU to obtain information about position of the linear axle 40, so as to obtain the parameters of the flatness and the vertical vibration. For measuring the linearity and lateral vibration of the linear axle 40, the sensor of the sensing unit 3 generates voltage signal resulted from change in the magnetic field on the toothed encoding set 22 due to the linear movement of the linear axle 40. Then, the MCU processes the voltage signal to calculate parameters of the linearity and lateral vibration of the linear axle 40.

Moreover, the sensor of the sensing unit 3 further generates signal resulted from change in the magnetic field on the position toothed encoding set 23 due to the linear movement of the linear axle 40, so as to obtain the parameters of displacement, speed and acceleration of the linear axle 40 for obtaining the incremental position of the linear axle 40.

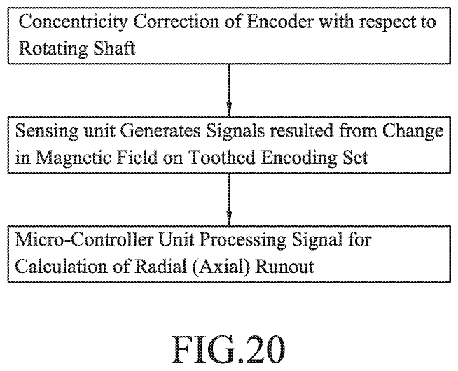

FIG. 20 is presented, alongside FIGS. 16 and 17, to further elaborate the measuring processes of the toothed encoding apparatus with one of the second and third embodiments. Initially, a concentricity correction is implemented, ensuring that the encoder 2 and the rotating shaft 4 are concentric with each other.

Next, during a rotational movement of the rotating shaft 4, if the toothed encoding apparatus with the encoder 2 of the second embodiment is mounted to the rotating shaft 4, the sensing unit 3 generates voltage signal resulted from change in the magnetic field on the toothed encoding set 22 due to movement in a radial direction (x, FIG. 16) of the rotating shaft 4. Then, the micro-controller unit (MCU) in the sensing unit 3 processes the voltage signal to calculate parameters of the radial runout or vibration of the rotating shaft 4. On the other hand, if the toothed encoding apparatus with the encoder 2 of the third embodiment is mounted to the rotating shaft 4, the sensing unit 3 generates the voltage signal resulted from change of the magnetic field on the toothed encoding unit 22 due to movement in an axial direction (y, FIG. 17) of the rotating shaft 4 instead, and the MCU processes the voltage signal to calculate parameters of the axial runout or vibration of the rotating shaft 4.

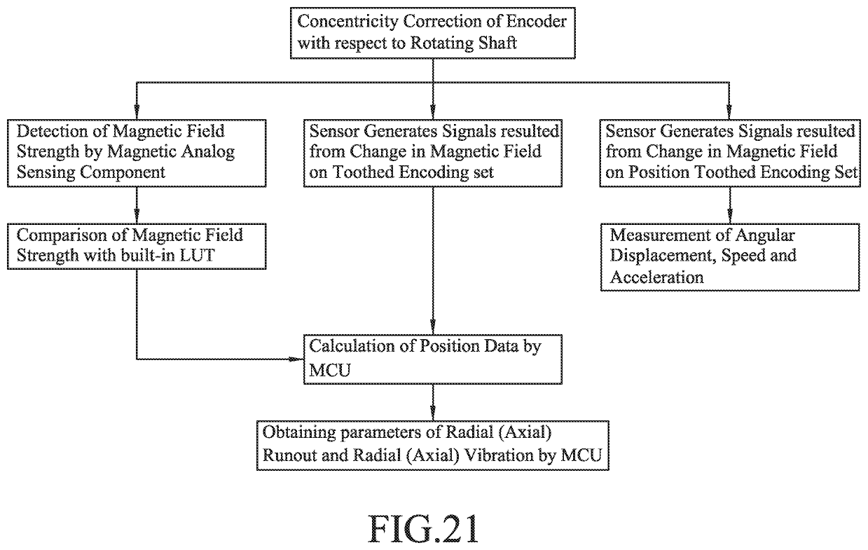

FIG. 21 is presented, alongside FIGS. 16 to 18, to further elaborate the measuring processes of the toothed encoding apparatus with the encoder 2 of one of the fourth, fifth, sixth and seventh embodiments.

Initially, a concentricity correction is implemented, ensuring that the encoder 2 and the rotating shaft 4 are concentric with each other.

Referring to the leftmost part of the flow chart of FIG. 21, during a rotational movement of the rotating shaft 4, when the encoder 2 of the fourth or fifth embodiment (FIGS. 7, 9 and 16) conducts measurements, the magnetic-analog sensing component of the sensing unit 3 senses the magnetic field strength, via magnetic flux, of the toothed encoding set 22. After obtaining a value of the magnetic field strength through the magnetic flux, the value is further compared to the built-in look up table (LUT) and processed by the MCU to obtain the parameters of the axial runout and axial vibration. Likewise, the parameters of the radial runout and radial vibration can be obtained when the encoder 2 of the sixth and seventh embodiments (FIGS. 11 and 13) conduct the measurements.

Next, referring to the middle part of the flow chart of FIG. 21, during the rotational movement of the rotating shaft 4, if the toothed encoding apparatus with the encoder 2 of the fourth or fifth embodiment is mounted to the rotating shaft 4, the sensing unit 3 generates voltage signal resulted from sinusoidal change in the magnetic field on the toothed encoding set 22 due to movement in a radial direction (x, FIG. 16) of the rotating shaft 4. Then, the MCU processes the voltage signal to calculate parameters of the radial runout and radial vibration of the rotating shaft 4. On the other hand, if the toothed encoding apparatus with the encoder 2 of the sixth or seventh embodiment is mounted to the rotating shaft 4, the sensing unit 3 generates the voltage signal resulted from change of the magnetic field on the toothed encoding set 22 due to movement in an axial direction (y, FIGS. 17 and 19) of the rotating shaft 4 instead, and the MCU processes the voltage signal to calculate parameters of the axial runout and axial vibration of the rotating shaft 4.

As the toothed encoding unit 201 of the encoder 2 of the disclosure is an integration of the toothed encoding set 22 and the position toothed encoding set 23, besides measuring the runout of the rotating shaft 4, the encoder 2 can also measure the angular-displacement (relative and absolute), speed, and acceleration of the rotating shaft 4. To do so, the sensing unit 3 senses the magnetic field of the position toothed encoding set 23 to calculate incremental or absolute position data through computational algorithms.

Specifically, referring to the rightmost part of the flow chart of FIG. 21, during the rotational movement of the rotating shaft 4, in addition to sensing the toothed encoding set 22, the sensing unit 3 also generates voltage signal resulted from change in the magnetic field on the position toothed encoding set 23 to obtain angular-position data of the rotating shaft 4.

In summary, the encoder 2 of some embodiment of the disclosure integrates the toothed encoding set 22 and the position toothed encoding set 23 on a linear main body 20 in such a manner that the recesses 221 of the toothed encoding set 22 are arranged in a direction different from the direction in which the recesses 231 of the position toothed encoding set 23 are arranged, so that, via cooperation with a sensing unit 3, the encoder 2 is capable of measuring flatness, linearity, vertical vibration, lateral vibration, displacement, speed and acceleration of a linear axle 40. In some embodiment, the encoder 2 includes a plurality of annular recesses 221, so that, via cooperation with a sensing unit 3, the encoder 2 is for measuring the axial and radial runouts of a rotating shaft 4. In some embodiment, the encoder 2 integrates the toothed encoding set 22 and the position toothed encoding set 23 on an annular main body 21, such that, in additions to measuring the axial and radial runouts of the rotating shaft 4 via the encoding unit 201, the encoder 2 can also measure the angular-position, speed and acceleration of the rotating shaft 4, via incremental-type or absolute-type signal received from the position toothed encoding unit 23.

In the description above, for the purposes of explanation, numerous specific details have been set forth in order to provide a thorough understanding of the embodiments. It will be apparent, however, to one skilled in the art, that one or more other embodiments may be practiced without some of these specific details.

It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An encoder comprising:
a main body made of material with magnetic permeability; and
a toothed encoding unit made of material with magnetic permeability, and including a toothed encoding set that is disposed on a surface of said main body, and a position toothed encoding set that is adjacent to said toothed encoding set and that is disposed on said surface of said main body on which said toothed encoding set is disposed, said toothed encoding set including a plurality of recesses that are disposed in a first direction, each of said recesses of said toothed encoding set extending in a second direction that is transverse to the first direction, said position toothed encoding set including a plurality of recesses that are disposed in the second direction, each of said recesses of said position toothed encoding set extending in the first direction.

2. An encoder comprising:
an annular main body made of material with magnetic permeability, surrounding a central axis, and having a first surface and a second surface that is opposite to said first surface; and
a toothed encoding unit made of material with magnetic permeability, and including a toothed encoding set that is disposed on one of said first surface and said second surface of said main body, and that includes a plurality of spaced-apart recesses, each of said recesses being annular and being centered at the central axis.

3. The encoder as claimed in claim 2, wherein:
a normal of each of said first and second surfaces is parallel to the central axis;
said toothed encoding set is disposed on said first surface; and
said recesses are arranged in a radial direction of said main body.

4. The encoder as claimed in claim 3, further comprising a fixing member that is mounted to an inner surrounding wall of said main body.

5. The encoder as claimed in claim 2, wherein:
a normal of each of said first and second surfaces is perpendicular to the central axis;
said second surface faces the central axis;
said toothed encoding set is disposed on said first surface; and
said recesses are arranged along the central axis.

6. The encoder as claimed in claim 5, further comprising a fixing member that is mounted to said second surface of said main body.

7. An encoder comprising:
an annular main body that is made of material with magnetic permeability, that surrounds a central axis, and that includes a first surface and a second surface opposite to said first surface; and
a toothed encoding unit made of material with magnetic permeability, and including a toothed encoding set that is disposed on one of said first surface and said second surface of said main body, and an annular position toothed encoding set that is centered at the central axis, that is adjacent to said toothed encoding set, and that is disposed on the one of said first surface and said second surface of said main body on which said toothed encoding set is disposed, said toothed encoding set including a plurality of spaced-apart recesses, each of said recesses of said toothed encoding set being annular and being centered at the central axis, said position toothed encoding set including a plurality of angularly spaced apart recesses that are disposed around the central axis.

8. The encoder as claimed in claim 7, wherein:
said main body further includes an inner surrounding wall proximate to the central axis and an outer surrounding wall opposite to said inner surrounding wall;
a normal of each of said first and second surfaces is parallel to the central axis;
said toothed encoding set and said position toothed encoding set are disposed on said first surface;
said recesses of said toothed encoding set are arranged in a radial direction of said main body;
each of said recesses of said position toothed encoding set extends in the radial direction of said main body; and
said position toothed encoding set is disposed on said first surface and between said toothed encoding set and one of said inner and outer surrounding walls.

9. The encoder as claimed in claim 8, further comprising a fixing member that is mounted to said inner surrounding wall of said main body.

10. The encoder as claimed in claim 7, wherein:
a normal of each of said first and second surfaces is perpendicular to the central axis;
said second surface faces the central axis;
said toothed encoding set and said position toothed encoding set are disposed on said first surface;
said recesses of said toothed encoding set are arranged along the central axis; and
each of said recesses of said position toothed encoding set extends in the direction of the central axis.

11. The encoder as claimed in claim 10, further comprising a fixing member that is mounted to said second surface of said main body.

12. The encoder as claimed in claim 7, wherein said position toothed encoding set is of one of absolute-type and incremental-type.

13. A toothed encoding apparatus adapted to be mounted to a linear axle for measuring vibration and displacement thereof, said magnetic encoding apparatus comprising:
an encoder of claim 1 that is adapted to be mounted to and disposed in an extending direction of the linear axle; and
a sensing unit that is spaced apart from said encoder, that corresponds in position to said toothed encoding set and said position toothed encoding set of said toothed encoding unit, and that includes a sensor for sensing the amplitude of the vibration of said toothed encoding unit, and a magnetic-analog sensing component for sensing magnetic field strength of said toothed encoding unit.

14. A toothed encoding apparatus adapted to be mounted to a rotating shaft for measuring runout thereof, said magnetic encoding apparatus comprising:
an encoder of claim 2 that is adapted to surround and to be mounted to the rotating shaft; and
a sensing unit that is spaced apart from said encoder, that corresponds in position to said toothed encoding unit, and that includes a sensor for sensing displacement of said toothed encoding unit, and a magnetic-analog sensing component for sensing magnetic field strength of said toothed encoding unit.

15. The toothed encoding apparatus as claimed in claim 14, wherein a normal of each of said first and second surfaces is parallel to the central axis, and an inner surrounding wall of said main body faces the rotating shaft.

16. The toothed encoding apparatus as claimed in claim 14, wherein a normal of each of said first and second surfaces is perpendicular to the central axis, and said second surface of said main body faces the rotating shaft.

17. The toothed encoding apparatus as claimed in claim 14, wherein said encoder further includes a fixing member via which said main body is connected to the rotating shaft.

18. The toothed encoding apparatus as claimed in claim 16, wherein said second surface of said main body is adapted to be in direct contact with an exterior of the rotating shaft.

19. The toothed encoding apparatus as claimed in claim 14, wherein said sensor is a giant magnetoresistance sensor, and said magnetic-analog sensing component is a Hall Effect sensor.
